(19) United States
(12) Patent Application Publication
(10) Pub. No.: US 2009/0043545 A1
(43) Pub. Date: Feb. 12, 2009

(54) Processing Data Representing Energy Propagating Through A Medium

(75) Inventors: Dirk-Jan van Manen, Redhill (GB); Andrew Curtis, Edinburgh (GB); Johan Olof Anders Robertsson, Oslo (NO)

Correspondence Address: SCHLUMBERGER-DOLL RESEARCH;ATTN: INTELLECTUAL PROPERTY LAW DEPARTMENT, P.O. BOX 425045, CAMBRIDGE, MA, 02142, US

(73) Assignee: WESTERNGECO, LLC, Houston, TX (US)

(21) Appl. No.: 11/665,243

(22) PCT Filed: Oct. 6, 2005
(86) PCT No.: PCT/GB05/03852

§ 371 Date: Mar. 7, 2008

(30) Foreign Application Priority Data
Oct. 13, 2004 (GB) 0422669.2

(51) Int. Cl. G06F 17/10

(52) U.S. Cl. 703/2

(57) ABSTRACT

The present invention relates to a method of processing data representing energy propagating through a medium (e.g., acoustic, elastic or electromagnetic energy) and describes an efficient and flexible e approach to forward modeling and inversion of such energy for a given medium. The representation theorem for the wave-equation is used, in combination with time-reversal invariance and reciprocity, to express the Green's function between two points in the interior of the model as an integral over the response in those points due to sources regularly distributed on a surface surrounding the medium and the points.

The present invention relates to a method of processing data representing energy propagating through a medium. Examples of applications of the invention include, but are not limited to, seismic data processing (where the data represents seismic energy propagating through the interior of the earth), non-destructive testing (where data might represent ultrasonic or electromagnetic energy propagating through an object under test), vibroacoustic analysis for, e.g., cars or airplanes, and imaging techniques in general. The invention also relates to the determination of relative Green's functions for systems of differential equations satisfying reciprocity and time-reversal invariance.

### BACKGROUND OF THE INVENTION

In a seismic survey, energy is emitted at a first point within or on the surface of the earth and the energy arriving at a second point (which is generally spatially separated from the first point) is recorded, usually in the form of a “trace” or “seismogram” showing the variation in the energy at the second point over a period of time. The first point is known as a source point and the second point is known as a receiver point. It is possible to obtain information about the earth's interior from the energy trace recorded at the receiver point, and from knowledge of the time of emission of energy at the source point and the waveform of the emitted energy at the source point. (The waveform of the emitted energy at the source point is known as the “source signature”.) Other imaging techniques are similar in principle, in that energy is emitted at one point in a medium, a record of the energy arriving at a second point in the medium is acquired, and information about the medium is derived from the acquired energy record.

There has been considerable effort put into modeling the expected energy waveform that will be acquired in a seismic data survey or other imaging method. For example, when a seismic survey is designed it is common practice to choose an arrangement of seismic sources and receivers, and to simulate the expected seismograms that will be acquired at the receiver locations for an assumed model of the earth's interior at the survey location. This process is repeated for many different arrangements of sources and receivers, so that an arrangement of sources and receivers that is expected to meet one or more criteria (for example to have a signal-to-noise ratio at the receivers that exceeds a user-determined threshold) can be selected for a seismic survey.

In general terms, this process can be summarized as calculating, for a given medium, for a source location in that medium, and for a source with a known source signature, the expected signal (or “record”) at another point in the medium consequent to actuation of the source. This is known as “forward modeling”. While this calculation is straightforward in principle, it requires many calculations to be made and so requires large amounts of processing power and memory. In the case of design of a seismic survey, for example, each possible survey arrangement will in general have more than one source location and a large number of receiver locations, and it is necessary to calculate the expected record for each possible pair of a receiver location and a source location. This process must be repeated for each survey arrangement that is considered, and may possibly be repeated for more than one model of the earth's interior.

It is therefore desirable to provide a computationally more efficient method of calculating the expected record at a point in a medium as a consequence of an excitation (such as the emission of energy) at another point in the medium. The record at a point in a medium, due to a (unidirectional) unit impulse, localized precisely in both space and time, is known as the “relative Green's function” between the two points. The Green's function can be a scalar (e.g., describing pressure, satisfying the acoustic wave-equation) or a tensor (e.g., describing the components of particle velocity/displacement due to unidirectional point forces, satisfying the elastic wave-equation). Also, note that the number of components of a Green's function can vary depending on the dimension of the wave-equation or, equivalently, the medium.

A Derode et al. disclose, in J. Acoust. Soc. Am., Vol. 113, No. 6, pp 2973-2976 (2003), a method of calculating the relative Green's function between two points in a medium. They simulate an excitation at one point in a medium, and compute the resultant records for points on a boundary enclosing the medium. The computed records are time-reversed and then re-injected into the medium simultaneously, and the record at a second point in the medium is computed. The result is the “relative Green's function” between the two points and its time-reverse. This process is described as a “time-reversed mirror”.

Cassereau, D., and Fink, M., “Time-Reversal of Ultrasonic Fields—Part III: Theory of the Closed Time-Reversal Cavity” in IEEE Trans. Ultrason. Ferroelectr. Freq. Control, 39[5], 579-592, 1992 discuss the use of two corresponding types of so-called “secondary sources” (monopole and dipole) used on the enclosing boundary to inject the normal derivative of the pressure (with respect to the enclosing boundary) in addition to the pressure record (reversed in time) back into the medium simultaneously. In their publication, Cassereau et al. make use of the Representation Theorem for the acoustic wave-equation, which forms the theoretical basis for computing the time-reversed wavefield inside the medium based on sources in the medium and measurements on a surface surrounding the medium).

### SUMMARY OF THE INVENTION

A first aspect of the present invention provides a method of determining respective relative Green's functions between each pair of a plurality of points in a medium, the method comprising the steps of: defining a boundary surrounding all of the plurality of points; defining M source locations on the boundary; and, for each of the plurality of points, computing M sets of records, each set of records corresponding to the excitation of a source or several sources in orthogonal directions at a respective one of the source locations.

As explained above, the Green's function can be either a scalar or a tensor having a number of components. For each source location one record must be computed for each point for each component of the Green's function. If the Green's function is a scalar each set of records need contain only one record. In the case of a Green's function where L components are required to specify the Green's function, each set of records must contain at least L records.

The boundary surrounding the plurality of points does not necessarily coincide with a physical boundary of the medium. Consequently even though the sources could be physical sources, they will in most of the applications of interests be modeled sources, in particularly with a signature chosen such that the calculation of the Green's function and its derivatives is possible or simplified.

In case of acoustic wave propagation two corresponding types of so-called “secondary sources” (monopole and dipole) can be used on the enclosing boundary to inject the normal derivative of the pressure (with respect to the enclosing boundary) in addition to the pressure record (reversed in time) into the medium simultaneously, similar to the methods suggested by Cassereau, D., and Fink, M., “Time-Reversal of Ultrasonic Fields—Part III: Theory of the Closed Time-Reversal Cavity” in IEEE Trans. Ultrason. Ferroelectr. Freq. Control, 39[5], 579-592, 1992.

In general, computation/injection of a time-reversed wavefield in the elastic or electromagnetic case may require modeling or measurement of a second, related, quantity (scalar or tensorial) in addition to the quantity that the Green's function represents as well as an additional source type. In the elastic case, for example, this second quantity is the traction across the boundary associated with the modeled or measured displacement. Exactly which quantities and source types, e.g. with orthogonal directions of excitation, are needed on the boundary follows from a Representation Theorem for the particular wave-equation, which, together with the boundary conditions on the enclosing surface, forms the theoretical basis of time-reversal.

In the following description of the invention outgoing (i.e., radiation) boundary conditions on the boundary are assumed to simplify the discussion. The invention, however, is not limited to these boundary conditions. The radiation boundary conditions may conveniently be implemented by including absorbing boundaries immediately outside the boundary on which the source locations are defined. This also serves to truncate the computational domain.

The method of the present invention allows determination of the relative Green's function between each pair of the plurality of points in the medium. The method is therefore computationally very efficient.

A second aspect of the present invention provides a method of processing data representing energy propagating in a medium, the method comprising the steps of: defining a boundary surrounding all of a plurality of points in a medium; defining M source locations on the boundary; and, for each of the plurality of points, computing M sets of records, each set of records corresponding to the excitation of a source at a respective one of the source locations.

The method may comprise determining respective relative Green's functions between each pair of the plurality of points in the medium.

The method may comprise determining a relative Green's function between two of the plurality of points from at least a first set of records computed for a first point corresponding to the excitation of a source at a first of the source locations, a second set of records computed for a second point corresponding to the excitation of a source at the first of the source locations, a third set of records computed for the first point corresponding to the excitation of a source at a second of the source locations and a fourth set of records computed for the second point corresponding to the excitation of a source at the second of the source locations.

The method may comprise using the or each determined Green's function in subsequent processing of the data.

Computing the records corresponding to the excitation of a source at one of the source locations may be performed simultaneously with computing the records corresponding to the excitation of a source at another of the source locations. The source at the one of the source locations is orthogonal to the source at the another of the source locations. This variant of the invention makes use of orthogonal sources located at different locations whereas applications mentioned above the use of orthogonal sources or different source types at a single location.

The data may represent seismic energy propagating through the earth's interior, acoustic energy propagating through a medium, elastic energy propagating through a medium, or electromagnetic energy propagating through a medium.

The data may be governed by Schroedinger's equation, by a hyperbolic set of differential equations, or by a set of differential equations satisfying reciprocity and time-reversal invariance.

The method may comprise: determining respective relative Green's functions between each pair of a first subset of a plurality of points in a medium; determining respective relative Green's functions between each pair of a second subset of a plurality of points in the medium; and comparing the relative Green's functions determined for the first subset of points with the relative Green's functions determined for the second subset of points. This embodiment of the invention may be applied to, for example, Survey Evaluation and Design (SED) of a seismic survey—the first subset of a plurality of points would represent the locations of seismic sources and seismic receivers for a first proposed survey geometry, and the second subset of a plurality of points would represent the locations of seismic sources and seismic receivers for a second proposed survey geometry. The relative Green's functions would correspond to the seismograms that would be expected to be recorded at the receivers in the two survey geometries and can be compared with one another to determine which survey geometry best satisfies a particular criterion such as, for example, a desired signal-to-noise ratio.

Each source may be a delta-pulse or other source types as required from analysis of the conditions set by the boundary and the respective representation theorem which governs the wave propagation inside the medium.

A third aspect of the invention provides an apparatus for determining respective relative Green's functions between each pair of a plurality of points in a medium, the apparatus comprising: means for defining a boundary surrounding all of the plurality of points; means for defining M source locations on the boundary; and means for, for each of the plurality of points, computing M sets of records, each set of records corresponding to the excitation of a source at a respective one of the source locations.

A fourth aspect of the invention provides an apparatus for processing data representing energy propagating in a medium, the apparatus comprising: means for defining a boundary surrounding all of a plurality of points in a medium; means for defining M source locations on the boundary; and means for, for each of the plurality of points, computing M sets of records, each set of records corresponding to the excitation of a source at a respective one of the source locations.

The apparatus may comprise a programmable data processor.

A fifth aspect of the invention provides a storage medium containing a program for the data processor of such apparatus.

A sixth aspect of the invention provides a storage medium containing a program for controlling a programmable data processor to carry out a method of the first aspect.

A seventh aspect of the invention provides a storage medium containing a program for controlling a programmable data processor to carry out a method of the second aspect.

The efficiency and flexibility of the methods according to the present invention result from the fact that the surface surrounding the medium is one dimension lower than the enclosed volume such that the number of sources is relatively small (compared to the number of possible source locations in the volume) and the fact that the computational cost of a typical forward modeling algorithm (e.g., finite differences) does not depend on the number of receivers inside the medium, as long as they are not more densely distributed than the points in the computational grid.

The invention may further comprise an initial forward modeling phase, where the response in the medium is computed in as many points of interest as possible, exciting sources on the surface surrounding the medium (one-by-one, or all simultaneously but encoded) and a second phase in which the actual Green's functions between pairs of points of interest are calculated from the records computed in the first step. This second step only requires cross-correlations and summations without additional forward modeling. A point of interest can both serve as a source and receiver location (or both simultaneously) and since the computational cost typically does not depend significantly on the number of points of interest, it increases the computational efficiency and flexibility to define as much points of interest as possible.

The methodology has applications in waveform inversion, imaging, survey evaluation and design, industrial and experimental design, and many other applications which make use of waves traveling through an medium to detect features of that medium. The methodology is hence not limited to seismic applications.

These and other features of the invention, preferred embodiments and variants thereof, possible applications and advantages will become appreciated and understood by those skilled in the art from the following detailed description and drawings.

### BRIEF DESCRIPTION OF THE DRAWINGS

FIG. 1 is a flow diagram illustrating principal steps of a method of the present invention;

FIG. 2 illustrates the application of a method of the present invention to a one-dimensional medium;

FIG. 3 illustrates the application of a method of the present invention to a two-dimensional medium;

FIGS. 4-9 illustrate the steps of FIG. 1 applied to the medium of FIG. 3; and

FIG. 10 shows components of an apparatus to perform the method of FIG. 1.

### MODE(S) FOR CARRYING OUT THE INVENTION

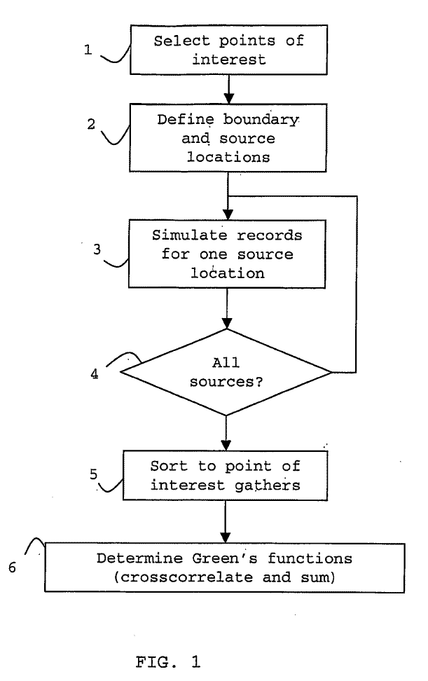

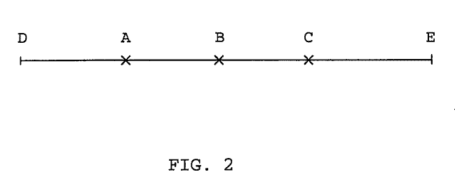

In FIG. 1 there is a flowchart showing the principle steps 1-6 of a method of the invention. The invention will be described with reference to FIG. 1, and also with reference to a very simple, one-dimensional example shown in FIG. 2 and more a more complex two-dimensional case shown in the flowing figures.

Initially, at step 1, the points of interest in a medium are identified. Every point in the medium for which it is desired to calculate (in combination with another point in the medium) a relative Green's function is a “point of interest”. The method of the invention enables the direct determination of a relative Green's function between two points, provided that both points have been identified as points of interest. However, a relative Green's function involving a point that is not identified in step 1 as a “point of interest” cannot be directly determined by the method of the invention (although it might be possible to estimate the relative Green's function using an interpolation/extrapolation technique). In the case of a seismic survey or other imaging method, every location at which it was intended to locate a source would be a point of interest, and every location at which it was intended to locate a receiver would be a point of interest.

The medium may represent, for example, a portion of the earth's interior (in seismic surveying), an object to be tested (in non-destructive imaging/testing) or, in general, any body or region for which it is desired to simulate wave propagation.

In FIG. 2 the three points of interest are labeled A, B and C. These are arranged along a straight line and could, for example, represent points in a borehole in the earth. Thus, in the example of FIG. 2 it is desired to determine the relative Green's functions between point A and point B, between point A and point C and between point B and point C.

At step 2 of FIG. 1 a boundary that encloses the points of interest is determined. Normally, the model of the medium will contain only those features that are considered relevant to the particular survey design, inversion, imaging, forward modeling or other application (i.e., features which may influence the response in a point of interest, given a source in (another) point of interest). The boundary defined in step 2 should enclose those features in addition to the points of interest, and hence typically surrounds the complete medium. The boundary surrounding the plurality of points does not, however, necessarily coincide with a physical boundary of the medium. Because of the additional absorbing boundaries surrounding the boundary defined in step 2 (in a case where the radiation boundary conditions are applied), the computational domain is generally slightly larger than the model under investigation.

Furthermore at step 2, M (where M is an integer) source locations are defined on the boundary. The criterion for distributing the sources on the boundary is that they should be sufficient to approximate a time-reversed mirror in the sense of Derode et al. and Cassereau et al. (above), for the frequency-wavenumber range of interest. In the simple 1-D example of FIG. 2, the boundary enclosing the points of interest A, B and C is formed of two points D and E which are arranged so that points A, B and C lie between point D and point E. One source location is accordingly defined at point D, and a second source location is defined at point E.

In almost all cases the condition M>1 holds so that two or more source locations are defined at step 2. In the simple case of a borehole with a reflecting boundary at the top, however, a single source location could be defined at step 2.

In principle, the medium may be any generalized N-dimensional volume, where N is an integer equal to or greater than 1. The boundary that encloses the points of interest in the medium will have a dimension of (N−1). Thus, if the medium is a 2-D medium a boundary enclosing the points of interest will be a line (1-D), if the medium is a 3-D medium a boundary enclosing the points of interest will be a surface (2-D), and so on. In the 1-D example of FIG. 2 the boundary comprises two points and hence is zero-dimensional (0-D).

Next, at step 3 as illustrated in FIG. 1, the record at each of the points of interest in response to excitation of a source at one of the source locations defined in step 2 is simulated. In the example of FIG. 2, step 3 would consist of simulating the record at each of points A, B and C when a source located at either point D or point E is excited. In general, the record simulated for a point will be a time series representing the variation in energy arriving at the point following excitation of the source—if the invention is applied to seismic data processing, for example, each record would be a synthetic (modeled) seismic data trace (seismogram) showing the seismic energy arriving at point A, B or C following excitation of a seismic source at point D. In this example it is assumed that step 3 consists of simulating the record at each of points A, B and C when a source located at point D is excited so that the result of step 3 is the records R_{AD}, R_{BD}, and R_{CD}, using a notation R_{JI} where R_{JI} denotes the record at point J when a source at point I is excited.

The record at each of points A, B and C is simulated using a model of the medium. The record may be simulated using any suitable modeling technique such as, for example, a finite difference (FD) technique or a finite element modeling (FEM) technique. Any desired source signature may be assumed in the simulation; one example of a source signature is a 8-function, but the invention is not limited to this.

The source may be a source of waves such as Seismic waves, acoustic waves, elastic waves, or electromagnetic waves. In the most general formulation of the invention, the source is a source of waves that are governed by a wave equation or system of equations. The source may be a source of waves governed by a hyperbolic set of differential equations or a set of differential equations satisfying reciprocity and time-reversal invariance; one example of this is waves governed by Schroedinger's equation.

Step 4 of FIG. 1 is a determination of whether step 3 has been carried out for each source location defined in step 2. If step 4 gives a “no” determination, step 3 is repeated for the next (or each further) source location. In the example of FIG. 2, step 3 would be repeated once, to simulate the record at each of points A, B and C when a source located at point E is excited and obtain the records R_{AE}, R_{BE}, and R_{CE}.

In the above example it is assumed that one record is simulated for each of points A, B and C each time that step 3 is carried out. This would be the case where the relative Green's function is scalar, for example in the case of acoustic waves. In many cases, however, the Green's function is a tensor in which case one record would be simulated for each component of the Green's function, each of points A, B and C, each time that step 3 is carried out. In addition, the boundary conditions on the boundary with source locations defined in step 2 and the Representation Theorem may require an additional secondary source type to be used and the corresponding response to be computed (e.g., dipole sources and their response in the acoustic case). In the general case, therefore one set of L records, where L is the number of components of the Green's function plus the number of components of the response due to the additional secondary source type, is simulated for each of points A, B and C each time that step 3 is carried out.

The total number of records simulated will be equal to the number of source locations on the boundary (M) multiplied by the number of points of interest multiplied by the number of quantities (L) needed to define the Green's functions (which may be L=1, for example for acoustic waves, or may be L>1, for example for elastic waves.)

Step 5 is an optional sorting step which will be described in detail when discussing the second (2-D) example.

At step 6 of FIG. 1, the relative Green's function between any two of points A, B and C may be determined from the records obtained at step 3. One way of doing this is to apply a reciprocity step, and then apply the method of Derode et al. The reciprocity step applies the relationship R_{AD}=R_{DA} in the acoustic case, although reciprocity becomes slightly more complicated in other cases such as, for example 2D or 3D elastic wave propagation.

Alternatively, the method can be based on an application of time-reversal as described for example by Cassereau, D., and Fink, M., 1992, Time-Reversal of Ultrasonic Fields—Part III: Theory of the Closed Time-Reversal Cavity, IEEE Trans. Ultrason. Ferroelectr. Freq. Control, 39(5), 579-592.

This approach is based on the representation theorem of Helmholtz-Kirchhoff:

$${p}_{tr} ( r , t ) = {∮}_{S} \underbrace{\{ {σ}_{0} ( {r}_{s} , t )}_{{secondary}_{source}} * {\underbrace{G ( r , t \vert {r}_{s} )}}_{{Green ' s function}_{satisfying the B . C .}} - \underbrace{{σ}_{1} ( {r}_{s} , t )}_{{secondary}_{source}} * {\underbrace{{n}_{s} \cdot {∇}_{s} G ( r , t \vert {r}_{s} )} \}}_{{normal derivative of}_{{Green ' s function}_{satisfying the B . C .}}} d s \qquad [ 1 ]$$

To compute the time-reversed wavefield that propagates backward into the medium, Cassereau et al. replace the secondary source terms in eq. [1] with the wavefield and its normal derivative measured in their first step using

$$\{ \begin{matrix}{σ}_{1} ( {r}_{s} , t ) = p ( {r}_{s} , T - t \vert {r}_{1} ) \\ {σ}_{0} ( {r}_{s} , t ) = {n}_{s} \cdot {∇}_{s} p ( {r}_{s} , T - t \vert {r}_{1} )\end{matrix} \qquad [ 2 ]$$

In the present method, the Green's function G and its normal derivative in equation [1] is identified with the response computed in one of the “points of interest” chosen in the above step 1 (denoted r₂) due to monopole and dipole sources on S (location rₛ). In addition, the secondary source terms σ₀ and σ₁ are identified with the time-reversed response computed in a second “point of interest” (denoted r₁) also due to monopole and dipole sources on S. It should be noted that this last identification amounts to an application of reciprocity since in equation [2] the secondary source terms σ₀ and σ₁ were originally defined by Cassereau et al. as the response due to sources inside the medium whereas it is proposed by the present invention to identify them also as monopole and dipole sources on the boundary surrounding the medium S (as defined in step 2). These identifications yield:

$$\overbrace{G ( {r}_{2} , t \vert {r}_{1} )}^{{Green ' s function}_{between r 1 and r 2}} - {\overbrace{G ( {r}_{2} , - t \vert {r}_{1} )}}^{{between r 1 and r 2}^{reversed Green ' s function}} = {∮}_{S} {\{ \underbrace{{n}_{s} \cdot {∇}_{s} G ( {r}_{1} , - t \vert {r}_{s} ) * G ( {r}_{2} , t \vert {r}_{s} )}}_{{cross \text{-} correlation of Green ' s functions}_{involving a source on the boundary}} - {\underbrace{G ( {r}_{1} , - t \vert {r}_{s} ) * {n}_{s} \cdot {∇}_{s} G ( {r}_{2} , t \vert {r}_{s} )} \}}_{{cross \text{-} correlation of Green ' s functions}_{involving a source on the boundary}} d S \qquad [ 3 ]$$

which only uses sources on the boundary S. The sources are monopole and dipole sources placed such that the dipole source term represents effectively the derivative of the Green's functions in eq. [1]. Equation [3] describes how the difference between the Green's function between two locations (r₁ and r₂) and its time-reversed can be determined using a sum or integral summing the contribution of all sources (monopole or dipole) towards a difference of cross-correlations of Green's function and their normal derivative at the two locations.

The calculated relative Green's functions may then be used in further processing steps. In an application to an imaging method for example, the relative Green's function between two points (which represent the response at one point consequent to emission of a pulse of energy at the other point) may be examined to determine whether a particular arrangement of energy sources and receivers provides acceptable quality data. Moreover, step 6 may be repeated for another arrangement of energy sources and receivers (by selecting a different subset of the points of interest defined in step 1) to allow the quality of data provided by one arrangement of energy sources and receivers to be compared with the quality of data provided by another arrangement of energy sources and receivers.

The method of the invention has a number of advantages over the method described by Derode et al. One advantage is that any desired source signature can be used in the simulation of the records at step 3 of FIG. 1 since the source locations are on the boundary enclosing the points of interest. The source signature is completely independent of the medium, so that the source has no prior dependence on the medium. In the method of Derode et al., in contrast, the sources are located in the interior of the medium, so that the signal received at a receiver location on the boundary of the medium will represent a convolution of the original source signature with a response of the medium. The time-reversed signal that is re-injected into the medium will therefore already contain a memory of the medium.

A further advantage of the invention is that it is computationally very efficient. In the example of FIG. 2, simulating the six records R_{AD}, R_{BD}, R_{CD}, R_{AE}, R_{BE}, and R_{CE} requires two forward modeling runs but allows all three of the relative Green's functions to be determined. When the sources are placed in the points of interest, on the other hand, and a time-reversed mirror approach is used (as disclosed by Derode et al.), three forward modeling runs are required to compute all three of the relative Green's functions. Moreover, if more points of interest had been defined in step 1 of the example of FIG. 2, the inter point relative Green's functions could also be obtained using only two forward modeling simulations. It may be helpful to note that if the boundary conditions on the surface with sources surrounding the medium require additional source types as discussed by Cassereau et al. (and above), double the number of initial forward modeling runs would be required and the method of the present invention would only become efficient when more than 4 points of interest had been defined in step 1 of this example. The time-reversal approach as described by Cassereau et al., using sources inside the medium would require 6 forward modeling runs compared to the 4 required by the present invention for the same number (4) of points. In this example it will be assumed that boundary conditions are such that only simple monopole sources are required on the boundary.

Moreover, once records have been simulated for points of interest, all the information necessary to obtain the relative Green's functions involving the points of interest is available. As an example, it could be desirable to determine the relative Green's function between point A and point B and the relative Green's function between point A and point C. In this case, the points of interest are points A, B and C so that it would be necessary to determine the six records R_{AD}, R_{BD}, R_{CD} R_{AE}, R_{BE}, and R_{CE} and then obtain the two relative Green's functions (between point A and point B, and between point A and point C) from the records. However, if it subsequently became of interest to obtain the relative Green's function between point C and point B this could be obtained from the already-existing records R_{AD}, R_{BD}, R_{CD}, R_{AE}, R_{BE}, and R_{CE}, and there would no need to simulate any additional records. In contrast, the method of Derode et al uses specific source-receiver pairs—energy is excited at one location, the energy reaching a point on the boundary is time reversed and re-injected into the medium, and the record at a second point in the medium is determined. The simulation must be repeated for each source-receiver pair.

Another advantage of the present invention is that it provides a compact representation of Green's functions within points in a volume. This is important as it reduces the storage requirements and makes looking up the Green's functions more efficient.

The method of the invention has been described with reference to a simple 1-D example, but the principles described in this example apply to a 2-D or 3-D medium. Regardless of the dimensions of the medium, the important steps are defining a boundary that encloses the points of interest, defining source locations on the boundary, and carrying out one or more forward simulations for each source location to determine the record for each point of interest consequent to excitation of a source at that location. Depending on the type and dimension of the wave-equation (i.e., scalar vs. vector, 2D vs. 3D), several forward simulations may have to be carried out for each source location. The key steps as described above, however, remain the same.

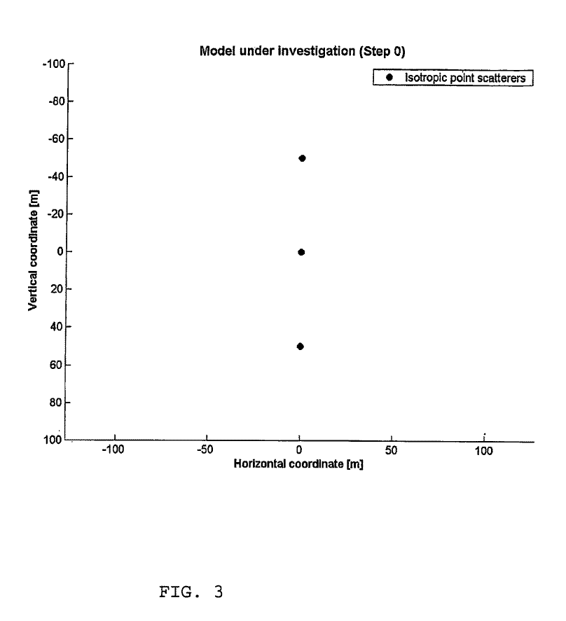

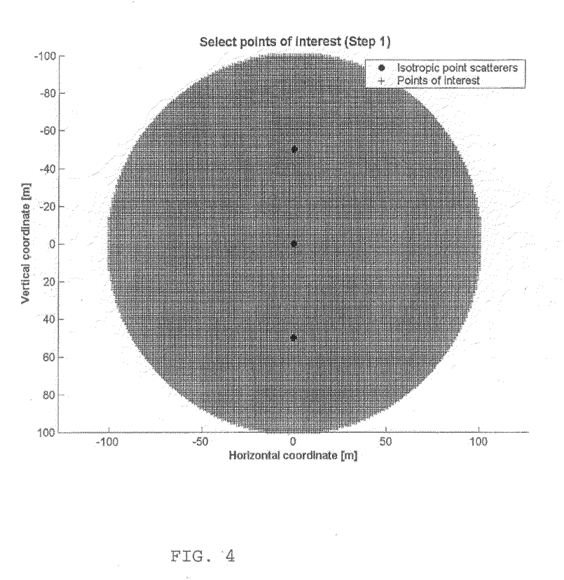

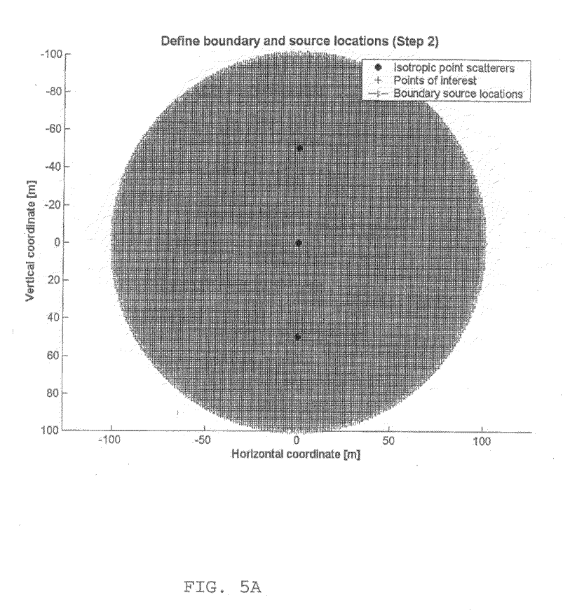

A two-dimensional medium is illustrated in FIG. 3. It is assumed to be homogeneous with the exception of three isotropic point scatterers, denoted by black dots.

Initially, at step 1 as referred to in FIG. 1, the points of interest in a medium are identified. Again, every point in the medium for which (in combination with another point in the medium) a relative Green's function is desired to be calculated is defined as a point of interest. The method of the invention enables the direct determination of a relative Green's function between two points, provided that both points have been identified as points of interest. However, a relative Green's function involving a point that is not identified in step 1 as a point of interest cannot be directly determined by the method of the invention (although it might be possible to estimate the relative Green's function using an interpolation/extrapolation technique). In the case of a seismic survey or other imaging method, every location at which it was intended to locate a source would be a point of interest, and every location at which it was intended to locate a receiver would be a point of interest, and in some applications (such as scattering or multiples analysis) every location at which the wavefield might be scattered, reflected or transmitted might also be a point of interest.

It is advantageous (in terms of computational efficiency and flexibility) to define as many points of interest within the model as possible, even though this increases storage requirements.

In FIG. 4, a number of 31415 points of interest are shown regularly distributed throughout the model at 1 m spacing. Thus, in the example it is desired to determine the relative Green's functions between any pair of the 31415 points of interest.

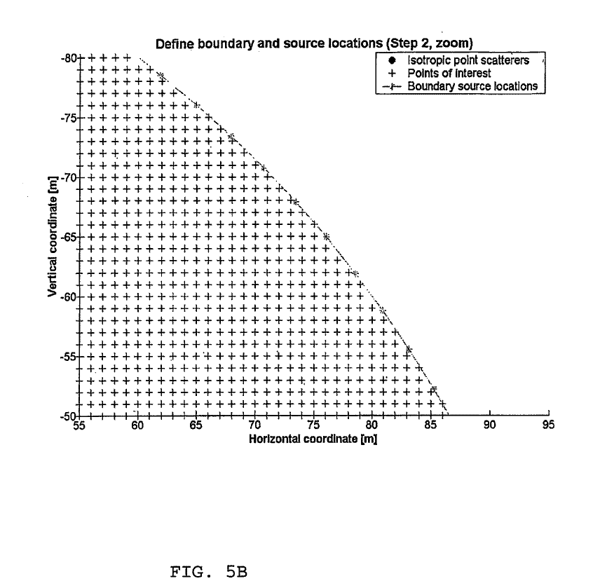

At step 2, a boundary that encloses the points of interest is determined and source locations are defined along the boundary. In the example in FIG. 5A, the boundary is a circle of radius 100 m with its centre at the origin of the model and 160 source locations were chosen spaced regularly along the circle every 3.927 m. The boundary is shown as solid line encircling the points of interest and individual source locations are marked with a star. An enlarged section showing points of interest (+), the boundary and sources (*) in a better distinguishable manner is shown in FIG. 5B.

The number of sources is chosen such that there are at least two sources per minimum wavelength of interest. Again, the criterion for distributing the sources on the boundary is that they should be sufficient to approximate a time-reversed mirror in the sense of Derode et al. (above), for the frequency-wavenumber range of interest. Note that in the 2-D example, the boundary is one-dimensional (1-D).

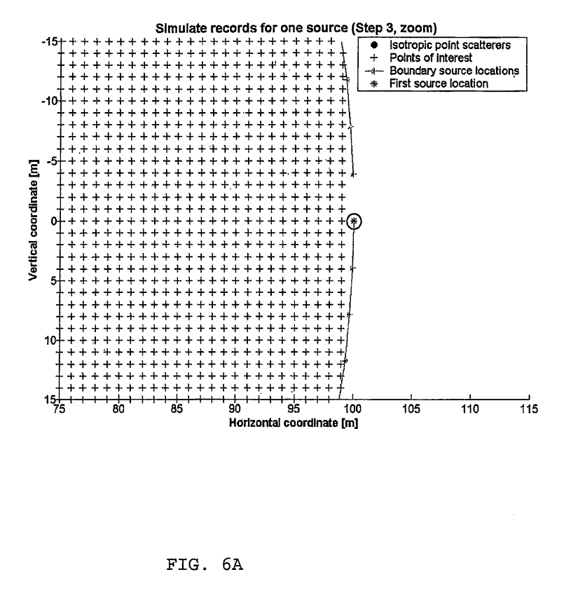

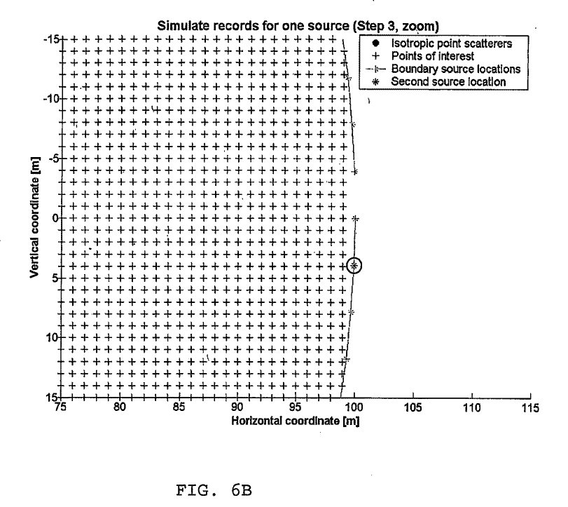

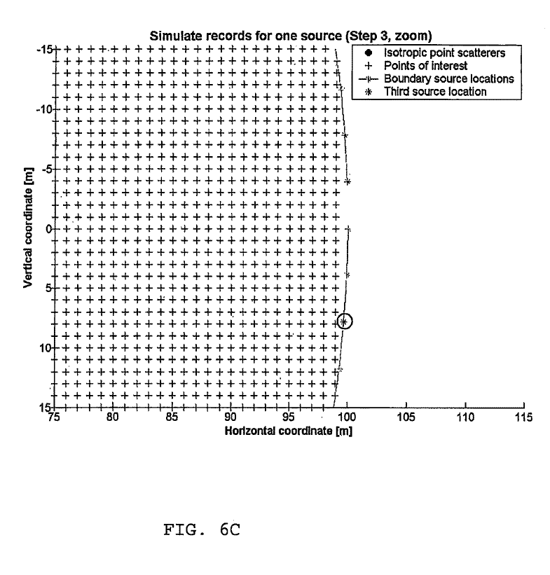

Next, at step 3, the record at each of the points of interest in response to excitation of a source at one of the source locations defined in step 2 is simulated. In the enlarged section shown in FIG. 6A, one possible single source that is excited is indicated with a circle. FIGS. 6B and 6C illustrate how one source after the other is excited (the active source again being marked by a circle) and the respective recordings of the wavefield at the 31415 points are recorded.

In this example, for which the results will be shown later, the records at the points of interest were modeled using Foldy's self-consistent approach (Foldy, L. L., The multiple scattering of waves, Phys. Rev., 67, 107-119, 1945) which includes all higher-order multiple interactions between the scatterers. However, the records may be simulated using any suitable modeling technique such as, for example, finite differences (FD).

It should be noted that in many modeling methods, especially finite differences, the computational cost mainly depends on the size and density of the computational grid (i.e., the number of gridpoints in the model). The density of the grid, in turn, is often dictated by the smallest wavelength of interest in the model (given a certain frequency band) and usually constant or only slowly varying throughout the model. On the other hand, computational cost does not depend on the number of receivers (i.e., points of interest) at which records are computed, as long as they are not more densely spaced than the gridpoints. This means that, without increasing the computational cost of a single finite difference run, records for every single point in the computational grid could be computed. Hence, the cost of modeling a whole survey of data is essentially determined by the number of source locations: For each source locations a finite difference run has to be calculated. Since in the present method the source locations are distributed along a (generalized) surface enclosing the medium, which is a dimension lower than the dimension of the medium, their number is relatively small (compared to the number of points of interest in the volume enclosed by the surface) and thus the computational cost of the novel method is limited. Therefore, it is advantageous to define as many points of interest as possible in the first step, as each point of interest can later be considered as a source or receiver location and relative Green's functions computed—increasing the number of such points does not increase the computational cost, other than storage. Thus, the flexibility and the number of different scenarios/surveys that can be evaluated after the main computations are increased.

Step 4 is a loop that is a determination of whether step 3 has been carried out for each source location defined in step 2. If the determination in “no”, step 3 is repeated for the next (or each further) source location. In the present example, step 3 is repeated 159 times, to simulate the records at each of the points of interest when each consecutive source on the boundary is excited.

In the above example it is assumed that one record is simulated for each point of interest each time that step 3 is carried out. This would be the case where the relative Green's function is scalar, for example in the case of acoustic waves and where the boundary conditions are outgoing (radiation) such that a single type of source can be used on the boundary. In many cases, however, the Green's function is a tensor with components G^{IL} (where I,Jε[1, 2, . . . , N] and N denotes the dimension of the medium) in which case at least N simulations for each source location would be required: one for excitation of a unidirectional point force source in each orthogonal direction (enumerated by J). Moreover, for each of the N simulations, N records would be computed for each point of interest: one for the particle displacement (or velocity) in each orthogonal direction (enumerated by I). It should be noted that superscript letters are used in this paragraph to indicate the components of the Green's function, and not to indicate the source and receiver locations which were previously indicated in subscripts referring to FIG. 2 above. Hence, G^{IJ}_{AB} means: the particle displacement (or velocity) in direction I, at point A, following the excitation of a unidirectional point force in direction J, at point B. Thus, for a three-dimensional (3-D) elastic medium, at least three forward modelling runs would be required for each source location (one for each unidirectional point source) and as part of each forward modelling run three components of the Green's function would have to be computed at each point of interest (corresponding to the particle displacement or velocity in each direction). So, in total, 9 records would have to be computed using three finite-difference runs to specify all the components of the Green's function tensor at a particular point of interest, for a particular source location.

It should be further noted that, depending on the Representation Theorem for the particular wave-equation (e.g., acoustic, elastic, electromagnetic) and the specific boundary conditions on the source surface surrounding medium, additional different source types may have to be used (e.g., dipole sources in the acoustic case) which may have to be excited in different directions as well. In such a case typically the number of finite difference runs required for each source location doubles. However, when outgoing (radiation) boundary conditions are present, the quantities in the Representation Theorem are related and one can be calculated from the other once it is computed, thus obviating the need for additional finite difference runs. For example, in the elastic case, there is a simple expression in the tangential wavenumber domain that relates the traction across the boundary with source locations to the particle displacement vector on the boundary.

When interpreting step 3, it should be understood that simulating all records for one source location includes any possible additional finite difference runs for each source orientation and/or source type as and when required under the circumstances or applications described in the previous two paragraphs.

Referring again to the acoustic two-dimensional example, the number of records simulated for each source location and each point of interest is two since the response was explicitly modelled for both source types (monopole and dipole.). Since the boundary conditions were outgoing on the surface of sources surrounding the medium, the dipole response could have been computed from the monopole response, or vice-versa, thereby reducing the number of records required to one.

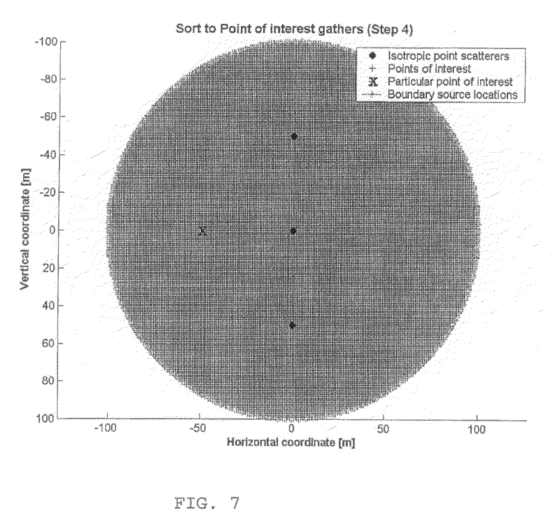

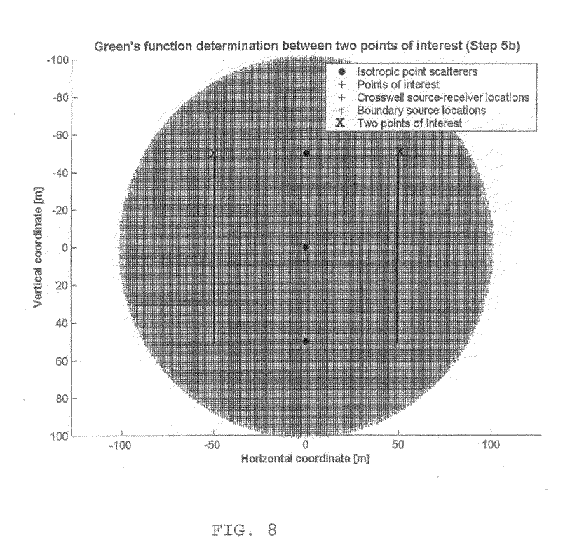

At step 5, after all forward simulations have been completed, all records are sorted to so-called “point of interest gathers”. A point of interest gather is the set of all traces modelled for the same point of interest (i.e., all traces that have a point of interest (shown as X in FIG. 7) in common) and the same source direction and/or source type. This means that in the 2-D acoustic example, where two source types are used at each of the 160 source locations along the boundary, 2 gathers of 160 traces each are created for each point of interest, one corresponding to all 160 monopole sources firing into that particular point of interest and one corresponding to all 160 dipole sources firing into that point of interest. This step is important for computational efficiency in the actual relative Green's function computation. However the step is optional and could in principle be left out when speed is not an issue. Alternatively, this step could be avoided when the computed records, while iterating over the source location, are not written to memory/disk in sequential fashion but stored directly in the appropriate location (i.e., where they would appear after sorting). This “inherent gather” option is likely to be an resource efficient compromise between gathering and no gathering as there is no uncertainty in the final location of the trace on disk and as it eliminates the sorting step.

At step 6, the relative Green's function between any two of points of interest may be determined from the records obtained at step 3 (to 5).

As an illustration of one of the many possible scenarios/surveys that can now be evaluated efficiently using the recorded data is shown in FIG. 8. The case to be modeled is a cross-well transmission and reflection setting. In FIG. 8, there are shown two wells with depths of 100 m on either side of the point scatterers. In each of the wells there are 101 receivers regularly spaced at 1 m. The middle point (X) of the left well and the top point (X) of the right well are selected as part of, the crosswell scenario to be evaluated.

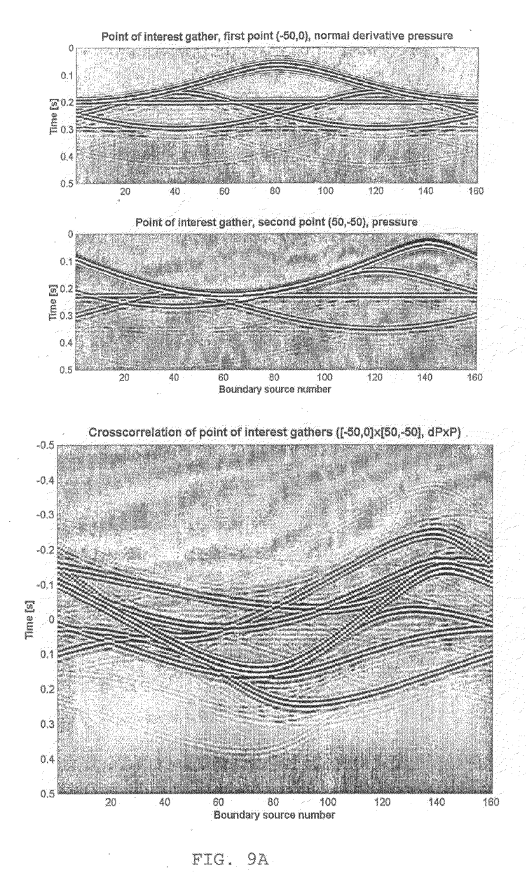

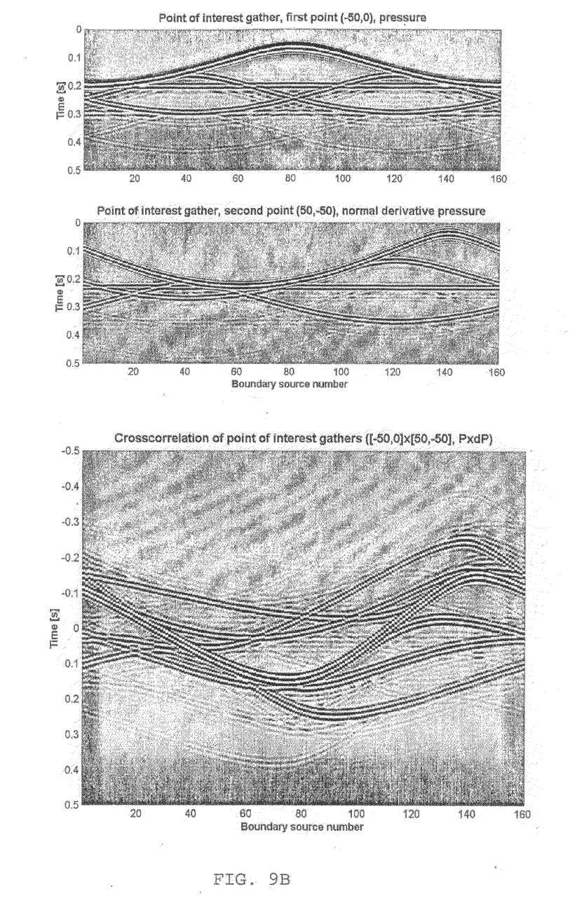

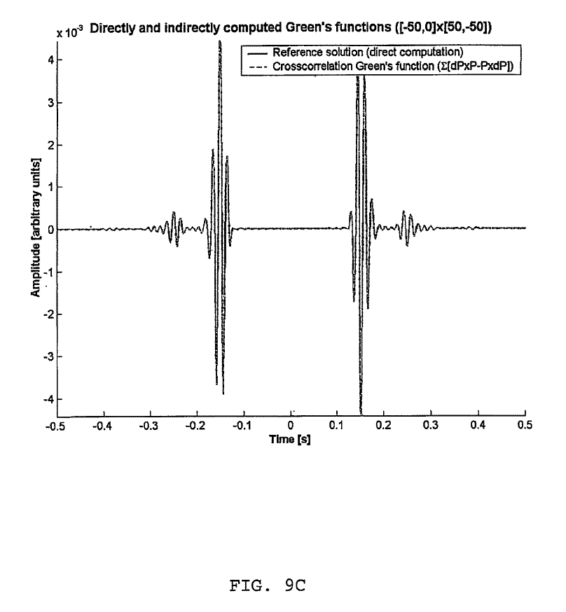

To calculate the relative Green's function between the selected two points, the gathers of the two point of interest (one for each source type) for both points are retrieved. These are displayed in the top and middle panels of FIGS. 9A and 9B.

According to equation [3] which is a more general version than the theorem by Derode et al., a cross-correlation of the recordings in the first point of interest due to the dipole sources on the boundary [top panel, FIG. 9A] with the recordings in the second point of interest due to the monopole sources on the boundary [middle panel, FIG. 9A] is required. The result of this first cross-correlation is shown in the bottom panel of FIG. 9A. These cross-correlations correspond to the first term in the integrand of the theorem of eq. [3], albeit in discretized form.

Similarly, the second term in the integrand of the theorem requires a cross-correlation of the recordings in the first point of interest due to the monopole sources on the boundary with the recordings in the second point of interest due to the dipole sources on the boundary. These recordings and their cross-correlation are shown in the top, middle and bottom panels of FIG. 9B, respectively.

The last step in the calculation of the relative Green's function between the two points is the subtraction of the two cross-correlation gathers (note the minus sign between the two terms in the integrand) and integrate, or sum (since the source locations on the boundary are discrete) over all source locations (i.e., the whole boundary) or the horizontal direction in the cross-correlation panels. The resulting relative Green's function, and a directly computed reference solution (minus its time-reverse) are shown in FIG. 9C. The match is excellent.

Note that when the two points of interest are coincident, there exists a zero-offset imaging condition from all of the boundary source points and this results in the Green's function from every point of interest to itself. This aspect of the invention can also be exploited in imaging and/or inversion.

The records at the points of interest may be simulated on the assumption that a point source of energy is positioned at the source location. The invention is not, however, limited to a point source of energy. Equivalently plane waves with different incidence angles (different tangential wavenumbers) could be used when formulating the algorithm in the wavenumber domain instead of the spatial domain. Any decomposition that allows a time-reversed mirror implementation could, in principle, be employed. Similarly, the invention could be implemented in the frequency domain instead of the time domain and the cross-correlations would be replaced by simple multiplications of records with phase-conjugated records. Obviously, the invention is not limited to a time domain implementation.

When defining the source locations along a boundary surrounding a two-dimensional (or higher-dimensional) medium, it is preferable to define sufficient source locations to enable the wavefield to be determined at the boundary without spatial aliasing. This requires two sources to be within a length of the boundary that is equal to the minimum wavelength of interest.

In principle, the distribution of source locations along the boundary may be unequal, in that the distance between adjacent source locations need not be constant. This may be the case if different parts of the boundaries have different properties. In that case, the contributions of the different parts of the boundaries need to be weighted in the summation (step 6) by the (generalized) area that each source location represents, such that the summation is a proper approximation of the surface integral that it discretizes. Moreover, in many seismic processing applications the top surface of the medium is bounded by a free-surface condition. In such a model, when the boundary containing the points of interest has been defined, no source locations should be placed on the portion of the boundary which contains the free surface. This can be understood from a method of imaging argument since such a model can be considered to be equivalent to a model which is mirrored and symmetric across the segment where the free surface is located.

For a case where one of the edges in a model of a medium has a free surface, the boundary surface that minimizes the number of source points on the circumference is a hemisphere capped by the free surface. However, approximations to the time-reversed mirror are possible, for example in a rectangular grid where the top surface is bounded by a free surface and the edges that are adjacent to the free surface have little influence on the modeled result (this is the case in many surface seismic and vertical seismic profile configurations), it is only necessary to distribute source locations along the portion of the boundary that represents the bottom face of the model of the medium and ignore all the side edges. It should be noted that such an approximation may result in loss of the direct wave or other arrivals that propagate more or less directly between pairs of points of interest that are close to the free surface. In many applications however, the direct wave between points at or near the surface is not considered to be very important so that the above approximation will yield reasonably accurate results.

In the method of FIG. 1, the records at the points of interest are simulated for the excitation of only one source, and this process is carried out for each source location in sequence. In principle, it would be possible to simulate the records for a case where all (or some of) the sources are excited simultaneously. This variant would significantly reduce the number of forward simulations needed. I may require use of sources the emission of which are separable.

The method of the present invention has many applications. One particular field in which the invention may be applied is processing or simulation of seismic data.

The applications of interest are those where it is necessary to generate Green's functions between points in the Earth model. Instead of needing to compute Green's functions for sources distributed in a volume (assuming a three-dimensional earth model) it will be necessary to make computations corresponding to source locations on a surface (and similarly will be necessary to make computations corresponding to source locations on a line in the case of a 2-D earth model). This can result in very substantial savings in computational cost. Moreover, the storage of Green's functions will be substantially more compact thus requiring less memory and computer power for looking up Green's functions. Possible applications of the invention to seismic data processing include the following:

Seismic Waveform inversion: Such methods require waveform modeling techniques such as FD modeling. The “FD-injection technique” developed by Robertsson and Chapman in GB-A-2 329 043 allows for the computation of updated Green's functions and recorded wavefields after making changes to material properties in one region of the model of the earth's interior.

The FD-injection technique of GB-A-2 329 043 allows for the update of Green's functions and recorded wavefields after making changes to material properties in the model. The FD-injection technique requires so-called injection wavefields to be generated in the unaltered model between desired source locations and a surface in the earth's sub-surface that surrounds the region of change (the so-called injection surface). Following a change in medium properties inside the injection surface and a new simulation on a much smaller model encompassing the injection surface and major nearby reflectors and scatterers, the newly generated wavefield must be extrapolated to the surface. This again requires relative Green's functions, now between the injection surface and the receiver locations of interest.

The FD-injection technique also requires knowledge of relative Green's functions between regions around the areas of change and the source/receiver locations. Moreover, after making a change to one region in the model, not only the Green's functions between the surface location and the region of interest should be updated but also those between other points in the sub-surface and source/receiver locations. The method of the present invention makes it possible to calculate the new relative Green's functions that are required after a change to material properties in one region of the earth model. The present invention in combination with the FD-injection technique can provide the key component (the forward modeler) of an efficient seismic waveform inversion scheme.

In principle, all of the Green's functions required for the method of GB-A-2 329 043 can be computed for distributed sources along a surface (at least for a surface seismic scenario) also in the case of multiple injection surfaces. However, what cannot be accomplished by conventional means is the interaction between different injection surfaces, i.e. to update the injection wavefields in one part of the model following an FD-injection computation on a different part of the model surrounded by a different injection surface.

The proposed invention makes it possible to update all required Green's functions even in the case of multiple injection surfaces. By again considering sources along the circumference of the model instead of the physical source/receiver locations in the surface seismic experiment, it is possible to employ the FD-injection technique to update all the required Green's functions between the source points on the circumference and points in the medium interior such that the time-reversal technique can be used to compute the new updated Green's functions after the model change between any points in the interior of the model. It should be noted that exactly the same assumptions and limitations that apply to the FD-injection technique that are discussed in GB-A-2 329 043 will apply to all the new Green's functions computed using the method of the invention when applied to the FD injection technique.

Imaging: Pre-stack seismic imaging schemes such as pre-stack finite-difference depth imaging, resemble many of the characteristics of waveform inversion and some methods require relative Green's functions to be computed between different points in the interior of the model. Examples include modelling and imaging techniques that employ multiple scattering approximations, for instance using the Lippman-Schwinger equation proposed by Snieder in “General theory of elastic wave scattering”, in Scattering and Inverse Scattering in Pure and Applied Science, Eds. Pike, R., and Sabatier, P., Academic Press, San Diego, 528-542 (2002) or other multiple scattering formulations such as the Neumann series:

$$u ( r ) = {u}_{0} ( r ) + {\sum }_{i} G ( r , {r}_{i} ) {A}_{i} {u}_{0} ( {r}_{i} ) + {\sum }_{i \neq j} G ( r , {r}_{i} ) {A}_{i} G ( {r}_{i} , {r}_{j} ) {A}_{j} {u}_{0} ( {r}_{j} ) + … \qquad [ 4 ]$$

Such methods require Green's functions between scattering locations in addition to Green's functions between scattering locations and source or receivers.

Intrabed multiples: Again this application may resemble much of the previously listed applications. Intrabed multiples can be a significant challenge and source of noise that obscure events of interest. However, they can also contain potentially valuable information about sub-surface properties. Their modeling will be significantly facilitated by efficient calculation of intrabed Green's functions.

Survey evaluation and design (SED): In SED various acquisition scenarios and well placements for observations are evaluated against each other. In essence, seismograms are simulated for each receiver for each arrangement of sources and receivers that is under consideration, so that the quality of the expected seismic data for each arrangement of sources and receivers can be evaluated. By definition such techniques will benefit from the current invention, as they will require the evaluation of Green's functions between almost arbitrary source/receiver locations. In particular SED for drilling observation wells for passive seismic monitoring or for cross-well monitoring is an example where the current invention will be of great interest. Today, many SED applications rely on simplistic so-called exploding reflector modeling scenarios to avoid having to compute the wavefield for many source locations. Such methods are very approximate and will not allow detailed analyses of the synthesized wavefield response. This will be facilitated by the current invention.

Representation of Green's functions within a seismic volume: Storage of Green's function between all points in an Earth model volume can be enormous. As pointed out above, the current invention makes it possible to reduce storage requirements substantially, by storing only the records R_{JI} from each perimeter source I to each point J in the Earth model, rather than Greens functions between all sources that could be distributed across the Earth model itself, thus requiring less memory space and computer power for look up.

The invention is not limited to use in processing or simulating seismic data. The method of the invention may be applied generally to a situation where energy such as elastic, acoustic, or electromagnetic energy propagates in a medium. In broadest terms, the invention is applicable to any physical system governed by sets of differential equations, in particular hyperbolic systems of differential equations (e.g., wave equations), provided that the principles of reciprocity and time-reversal invariance are satisfied, since the solutions of such sets of differential equations are related to Green's functions. As an example, the method of the invention may be applied to a physical system in which the propagation of energy is governed by Schroedinger's equation.

Examples of applications of the invention outside the field of seismic data processing include:

General Waveform inversion. Such methods require waveform modeling techniques such as FD. The FD-injection technique of GB-A-2 329 043 is not limited to seismic data processing but is applicable to any situation in which waveform inversion is required. As explained above, the present invention in combination with the FD-injection technique of GB-A-2 329 043 can provide the forward modeler in an efficient waveform inversion scheme.

In inversion applications it is possible to use Born theory to compute the Frechet derivatives to update the model. Born in combination with the FD-injection technique enable computation of the Frechet derivatives after the model update. This applies to inversion in seismic data processing as well as to inversion in other fields.

Another example of a technique that would be facilitated is one for calculating integrals over multiply-scattering perturbations to a background medium in which Green's functions—in the background medium—between locations of such perturbations are required (see e.g., Snieder in “General theory of elastic wave scattering”, in Scattering and Inverse Scattering in Pure and Applied Science, Eds. Pike, R., and Sabatier, P., Academic Press, San Diego, 528-542 [2002])

Imaging: Imaging schemes such as those that compute Kirchhoff or (generalized) Radon transform integrals from recorded data, resemble many of the characteristics of waveform inversion and some methods require Green's functions to be computed between different points in the interior of the model. The present invention may be applied to the calculation of such Green's functions.

Intra-body multiples: Again this application may resemble some of the previously listed applications. Intra-body multiples (i.e., waves bouncing more than once between velocity contrasts) can contain significant information about properties of the volume being modeled, or may be regarded as a source of noise that obscures wave arrivals of interest. In the former case it may be useful to model the multiples, in the latter case it may be useful to model then multiples and then subtract (remove) the multiples from the data.

Experimental design: In the design of an experiment, various data acquisition systems are evaluated against each other. Such techniques will benefit from the current invention as they may require the evaluation of Green's functions between almost arbitrary source locations and receiver locations.

Industrial design: To optimize the wave response (for example, acoustic, elastic, electromagnetic and, Schroedinger's equation) of non-oilfield related objects, such as used in vibroacoustic analysis of cars, airplanes or industrial facilities, or chemical or biological systems, a model of the system must be interrogated for a very large number of source/receiver pairs. The method of the invention makes modeling such scenarios, and subsequently inverting the data for properties of the system more efficient both in terms of computation, and in terms of storage of Green's functions (see below).

Absorbing boundary conditions (ABC) for FD simulations: Such techniques are needed to truncate the computational domain in FD calculations. Amundsen et al. describe in the international published patent application WO 03/036331 (Amundsen, L., Holvik, E., and Robertsson, J. O. A., Method for multiple removal in seismic data) a methodology for multiple suppression of seismic data based on the representation theorem that is directly applicable to for instance FD data simulated in the reciprocal arrangement as described in this invention. The method by Amundsen et al., partitions the volume of wave propagation into two domains, one interior to a recording surface (or a recording surface and a surface in infinity where the wavefield vanishes in accordance with Sommerfeldt's radiation condition) and one exterior to the recording surface. The method by Amundsen et al., allows for removing whatever structure or boundary conditions that exist in the exterior domain and replace it by a perfectly radiating boundary condition which backscatters no energy. In the case of the present invention, it is possible to use any boundary condition such as a Dirichlet or von Neumann boundary condition outside the surface with all source locations on the boundary. Once all the desired Green's functions between the source points on the surrounding surface and all points of interest inside it are computed, the technique of Amundsen et al. can be applied to transform all these data to that of a situation where all Green's functions correspond to that of a radiating boundary condition with no backscattered energy. Note that this methodology does not add any computations in the FD calculations but instead adds a separate step following the FD simulation and before the cross-correlations take place to solve integral equations to remove the effects of the boundary condition used in the FD simulation. However, as an absorbing boundary condition can be expensive to include in the FD computation and since it usually has problems of accuracy and stability, particularly for energy incident under low grazing angles, substantial gains can be expected from using this new method, at least under some circumstances where the number of points of interest is not too large.

Modeling and inversion for propagating source/rupture processes: Since the present invention allows computation of the Green's function for any source-receiver pair (as long as they were defined as points of interest beforehand), the response involving a moving source (e.g., a seismological rupture process, where the rupture can be modeled by assuming a source propagating along a pre-existing or newly created fault), can also efficiently be computed after the main calculations for sources on the boundary have been done. This again makes up for an efficient modeler in an inversion scheme set-up to invert for such rupture parameters (e.g., source propagation path, velocity etc.) Another example could be the task of tracking a helicopter, flying in a reverberatory environment such as between several skyscrapers, based on one or more recordings of the sound.

Movie industry: Since visible light is a form of electromagnetic wave propagation, the present invention may provide a computationally efficient method of rendering a movie scene for any combination of light source location and observation point within the scene (as long as they were previously identified as points of interest). In this application, first the response at all points of interest is calculated for light sources on a surface enclosing the medium. Next the particular desired response is calculated by cross-correlation and summation of the surface responses, analogous to what has been described previously. Relevant in this context are also phase conjugation mirrors, the optical equivalent of time-reversed mirrors.

Representation of Green's functions within a volume: The above comments made on this topic in relation to seismic data processing apply also to applications outside the field of seismic data processing.

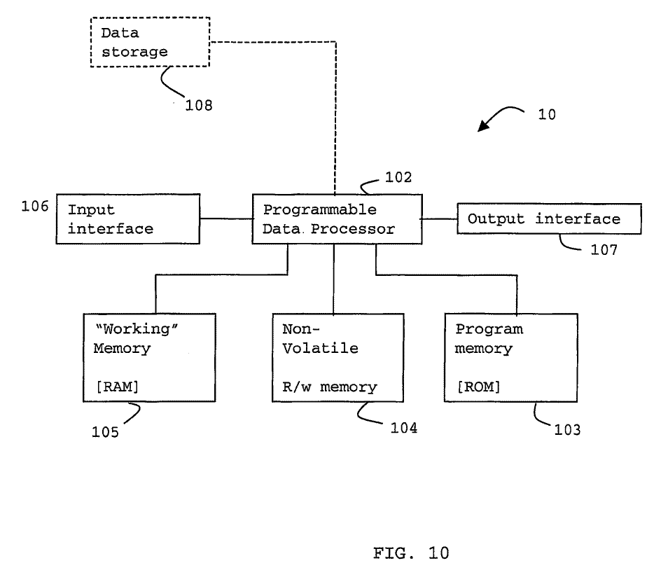

FIG. 10 is a schematic block diagram of a programmable apparatus 10 according to the present invention. The apparatus comprises a programmable data processor 102 with a program memory 103, for instance in the form of a read-only memory (ROM), storing a program for controlling the data processor 102 to perform any of the processing methods described above. The apparatus further comprises non-volatile read/write memory 104 for storing, for example, any data to be retained in the absence of power supply. A “working” or scratch pad memory for the data processor is provided by a random access memory (RAM) 105. An input interface 106 is provided, for instance for receiving commands and data. An output interface 107 is provided, for instance for displaying information relating to the progress and result of the method. Seismic data for processing may be supplied via the input interface 106, or may alternatively be retrieved from a machine-readable data store 108.

The program for operating the system and for performing a method as described hereinbefore is stored in the program memory 103, which may be embodied as a semi-conductor memory, for instance of the well-known ROM type. However, the program may be stored in any other suitable storage medium, such as magnetic data carrier, such as a “floppy disk” or CD-ROM.

1. A method of determining respective relative Green's functions between each pair of a plurality of points in a medium, the method comprising the steps of: defining a boundary surrounding all of the plurality of points; defining M source locations on the boundary; and, for each of the plurality of points, computing M sets of records, each set of records corresponding to the excitation of a source or multiple sources in one or more orthogonal orientations at a respective one of the source locations.

2. A method as claimed in claim 1 and comprising the step determining the relative Green's function between two of the plurality of points from at least a first set of records computed for a first point corresponding to the excitation of a source at a first of the source locations, a second set of records computed for a second point corresponding to the excitation of a source at the first of the source locations, a third set of records computed for the first point corresponding to the excitation of a source at a second of the source locations and a fourth set of records computed for the second point corresponding to the excitation of a source at the second of the source locations.

3. A method of processing data representing energy propagating in a medium, the method comprising the steps of: defining a boundary surrounding all of a plurality of points in a medium; defining M source locations on the boundary; and, for each of the plurality of points, computing M sets of records, each set of records corresponding to the excitation of a source or multiple sources in one or more orthogonal orientations at a respective one of the source locations.

4. A method as claimed in claim 2 and comprising the step of determining respective relative Green's functions between each pair of the plurality of points in the medium.

5. A method as claimed in claim 3 and further comprising determining a relative Green's function between two of the plurality of points from at least a first set of records computed for a first point corresponding to the excitation of a source at a first of the source locations, a second set of records computed for a second point corresponding to the excitation of a source at the first of the source locations, a third set of records computed for the first point corresponding to the excitation of a source at a second of the source locations and a fourth set of records computed for the second point corresponding to the excitation of a source at the second of the source locations.

6. A method as claimed in claim 4 and comprising using the or each determined Green's function in subsequent processing of the data.

7. A method as claimed in claim 3 wherein computing the records corresponding to the excitation of a source at one of the source locations is performed simultaneously with computing the records corresponding to the excitation of a source at another of the source locations.

8. A method as claimed in claim 7 wherein the source at the one of the source locations is orthogonal to the source at the another of the source locations.

9. A method as claimed in claim 3, wherein the data represent seismic energy propagating through the earth's interior.

10. A method as claimed in claim 3, wherein the data represent acoustic energy propagating through a medium.

11. A method as claimed in claim 3, wherein the data represent elastic energy propagating through a medium.

12. A method as claimed in claim 3, wherein the data represent electromagnetic energy propagating through a medium.

13. A method as claimed in claim 3, wherein the data are governed by Schroedinger's equation.

14. A method as claimed in claim 3, wherein the data are governed by a hyperbolic set of differential equations.

15. A method as claimed in claim 3 wherein the data are governed by a set of differential equations satisfying reciprocity and time-reversal invariance.

16. A method as claimed in claim 1 and comprising: determining respective relative Green's functions between each pair of a first plurality of points in a medium; determining respective relative Green's functions between each pair of a second plurality of points in the medium; and comparing the relative Green's functions determined for the first plurality of points with the relative Green's functions determined for the second plurality of points.

17. A method as claimed in claim 3 wherein each source is a delta-pulse.

18. An apparatus for determining respective relative Green's functions between each pair of a plurality of points in a medium, the apparatus comprising: means for defining a boundary surrounding all of the plurality of points; means for defining M source locations on the boundary; and means for, for each of the plurality of points, computing M sets of records, each set of records corresponding to the excitation of a source or multiple sources in one or more orthogonal orientations at a respective one of the source locations.

19. An apparatus for processing data representing energy propagating in a medium, the apparatus comprising: means for defining a boundary surrounding all of a plurality of points in a medium; means for defining M source locations on the boundary; and means for, for each of the plurality of points, computing M sets of records, each set of records corresponding to the excitation of a source or multiple sources in one or more orthogonal orientations at a respective one of the source locations.

20. An apparatus as claimed in claim 19 comprising a programmable data processor.

21. A storage medium containing a program for the data processor of an apparatus as defined in claim 20.

22. A storage medium containing a program for controlling a programmable data processor to carry out a method as defined in claim 1.

23. A storage medium containing a program for controlling a programmable data processor to carry out a method as defined in claim 3.
